(19) United States
(12) Patent Application Publication
(10) Pub. No.: US 2026/0163139 A1
(43) Pub. Date: Jun. 11, 2026

(54) SECONDARY BATTERY

(71) Applicant: MURATA MANUFACTURING CO., LTD., Kyoto (JP)

(72) Inventor: Masayuki KAGEYAMA, Kyoto (JP)

(21) Appl. No.: 19/380,128

(22) Filed: Nov. 5, 2025

(30) Foreign Application Priority Data
Dec. 6, 2024 (JP) 2024-213791

(51) Int. Cl. H01M 50/171; H01M 50/107; H01M 50/152; H01M 50/593

(52) U.S. Cl. CPC H01M 50/171; H01M 50/107; H01M 50/152; H01M 50/593

(57) ABSTRACT

A secondary battery includes a battery device to which a lead is coupled, a container, a cover part, and a first insulating part. The cover part includes first and second electrically conductive members. The cover part includes first and second joining regions in each of which the first and second electrically conductive members are mechanically joined to each other. In the first joining region, the first and second electrically conductive members are electrically coupled to each other. In the second joining region, the first and second electrically conductive members are electrically insulated from each other. A second joining strength with which the first and second electrically conductive members are joined to each other in the second joining region is higher than a first joining strength with which the first and second electrically conductive members are joined to each other in the first joining region.

### CROSS-REFERENCE TO RELATED APPLICATIONS

The present application claims priority from Japanese Patent Application No. 2024-213791 filed on December 6, 2024, the entire contents of which are hereby incorporated by reference.

### BACKGROUND

The present disclosure relates to a secondary battery in which a battery device is contained in a container.

Various kinds of electronic equipment, including mobile phones, have been widely used. Such widespread use has invoked a need for a smaller size, a lighter weight, and a longer life of the electronic equipment. To address the need, a secondary battery having a smaller size, a lighter weight, and a longer life has been developed as a power source of the electronic equipment.

A secondary battery includes a positive electrode, a negative electrode, and an electrolytic solution. In order to suppress occurrence of malfunction caused by a gas generated due to, for example, a decomposition reaction of the electrolytic solution, the secondary battery includes a safety mechanism configured to cut off a current path from a battery device to an external terminal on an as-needed basis.

### SUMMARY

A secondary battery according to an embodiment of the present disclosure includes a battery device to which a lead is coupled, a container, a cover part, and a first insulating part. The container contains the battery device. The cover part covers the container and the battery device contained in the container. The first insulating part seals the container and the cover part. The cover part includes a first electrically conductive member and a second electrically conductive member. The first electrically conductive member has an opening. The second electrically conductive member is attached to the first electrically conductive member via a second insulating part and covers the opening. The second electrically conductive member is coupled to the lead through the opening. The cover part includes a first joining region and a second joining region in each of which the first electrically conductive member and the second electrically conductive member are mechanically joined to each other. In the first joining region, the first electrically conductive member and the second electrically conductive member are electrically coupled to each other. In the second joining region, the first electrically conductive member and the second electrically conductive member are electrically insulated from each other. A second joining strength with which the first electrically conductive member and the second electrically conductive member are joined to each other in the second joining region is higher than a first joining strength with which the first electrically conductive member and the second electrically conductive member are joined to each other in the first joining region.

A secondary battery according to an embodiment of the present disclosure includes a battery device to which a lead is coupled, a container, a cover part, and a first insulating part. The container contains the battery device. The cover part covers the container and the battery device contained in the container. The first insulating part seals the container and the cover part. The cover part includes a first electrically conductive member and a second electrically conductive member.

The first electrically conductive member has an opening. The second electrically conductive member is attached to the first electrically conductive member via a second insulating part and covers the opening. The second electrically conductive member is coupled to the lead through the opening. A current path from the battery device to the cover part is configured to be cut off by generation of a gap between the first electrically conductive member and the second electrically conductive member caused by an increase in internal pressure of the container.

### BRIEF DESCRIPTION OF THE FIGURES

The accompanying drawings are included to provide a further understanding of the present disclosure and are incorporated in and constitute a part of this specification.

The drawings illustrate example embodiments and, together with the specification, serve to explain the principles of the present disclosure.

FIG. 1 is a sectional diagram illustrating an overall configuration example of a secondary battery according to one example embodiment of the present disclosure.

FIG. 2 is a sectional diagram illustrating a configuration example of an upper part of the secondary battery illustrated in FIG. 1.

FIG. 3 is a plan diagram illustrating a configuration example of a safety valve mechanism of the secondary battery illustrated in FIG. 1.

FIG. 4 is a sectional diagram illustrating, in an enlarged manner, a part of a configuration of a battery device illustrated in FIG. 1.

FIG. 5A is a first sectional diagram describing an operation of the safety valve mechanism illustrated in FIG. 2.

FIG. 5B is a second sectional diagram describing the operation of the safety valve mechanism illustrated in FIG. 2.

FIG. 6 is a plan diagram illustrating a configuration example of a safety valve mechanism according to a first modification example of one example embodiment of the present disclosure.

FIG. 7 is a plan diagram illustrating a configuration example of a safety valve mechanism according to a second modification example of one example embodiment of the present disclosure.

FIG. 8A is a sectional diagram illustrating a configuration example of a safety valve mechanism according to a third modification example of one example embodiment of the present disclosure.

FIG. 8B is a plan diagram illustrating the configuration example of the safety valve mechanism of the secondary battery illustrated in FIG. 8A.

FIG. 8C is a first sectional diagram describing an operation of the safety valve mechanism illustrated in FIG. 8A.

FIG. 8D is a second sectional diagram describing the operation of the safety valve mechanism illustrated in FIG. 8A.

FIG. 9A is a plan diagram illustrating a configuration example of a coupling part according to a fourth modification example of one example embodiment of the present disclosure.

FIG. 9B is a sectional diagram illustrating a configuration example of a coupling part according to a fifth modification example of one example embodiment of the present disclosure.

FIG. 9C is a plan diagram illustrating a configuration example of a coupling part according to a sixth modification example of one example embodiment of the present disclosure.

FIG. 10 is a sectional diagram illustrating a configuration example of a safety valve mechanism of a secondary battery according to one example embodiment of the present disclosure.

FIG. 11A is a first sectional diagram describing an operation of the safety valve mechanism illustrated in FIG. 10.

FIG. 11B is a second sectional diagram describing the operation of the safety valve mechanism illustrated in FIG. 10.

FIG. 12 is a block diagram illustrating a configuration of an application example of the secondary battery, which is a battery pack.

### DETAILED DESCRIPTION

Consideration has been given in various ways to improve performance of a secondary battery. There is, however, still room for improvement in terms of the performance of the secondary battery.

It is desirable to provide a secondary battery having superior performance.

In the following, the present disclosure is described in further detail including with reference to the accompanying drawings according to an embodiment. Note that the following description is directed to illustrative examples of the present disclosure and not to be construed as limiting to the present disclosure. Factors including, without limitation, numerical values, shapes, materials, components, positions of the components, and how the components are coupled to each other are illustrative only and not to be construed as limiting to the present disclosure. Further, elements in the following example embodiments which are not recited in a most-generic independent claim of the present disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the present disclosure are unillustrated in the drawings.

First, a description is given of a secondary battery according to a first example embodiment of the present disclosure.

The present example embodiment will be described referring, as an example, to a cylindrical secondary battery having an outer appearance of a cylindrical shape. However, a secondary battery of an embodiment of the present disclosure is not limited to the cylindrical secondary battery, and in an embodiment, may be a secondary battery having an outer appearance of a shape other than the cylindrical shape.

Although a charge and discharge principle of the secondary battery is not particularly limited, the following description deals with a case where a battery capacity is obtained through insertion and extraction of an electrode reactant. The secondary battery may include a positive electrode, a negative electrode, and an electrolyte.

Although not particularly limited in kind, the electrode reactant may be, for example, a light metal such as an alkali metal or an alkaline earth metal. Non-limiting examples of the alkali metal may include lithium, sodium, and potassium. Non-limiting examples of the alkaline earth metal may include beryllium, magnesium, and calcium.

In the following, described as an example is a case where the electrode reactant is lithium. A secondary battery in which the battery capacity is obtained through insertion and extraction of lithium may be what is called a lithium-ion secondary battery. In the lithium-ion secondary battery, lithium may be inserted and extracted in an ionic state.

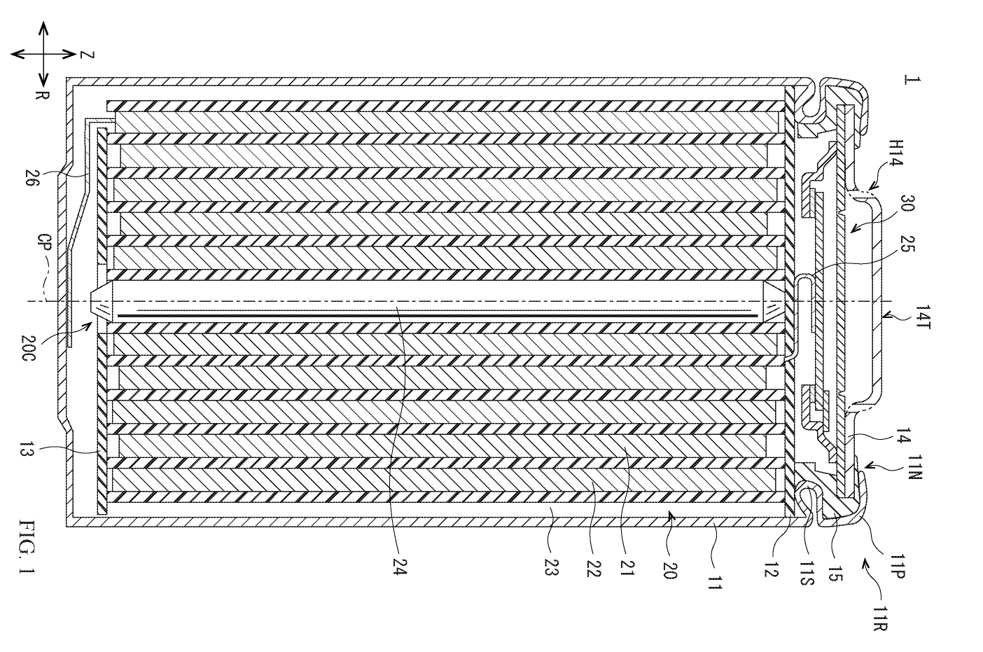

FIG. 1 illustrates a sectional configuration of a secondary battery 1 according to the first example embodiment. The secondary battery 1 includes a battery can 11 and a battery device 20, as illustrated in FIG. 1. The battery can 11 contains the battery device 20 inside the battery can 11. The battery can 11 may have a cylindrical shape. A reference sign CP denotes a central axis of the secondary battery 1.

Hereinafter, a direction in which the battery device 20 is placed into the battery can 11, e.g., a height direction of the battery can 11 having the cylindrical shape, is referred to as a Z direction; and a radial direction of the battery can 11 having the cylindrical shape is referred to as an R direction.

For example, in the secondary battery 1 illustrated in FIG. 1, for example, a pair of insulating plates 12 and 13 and the battery device 20 may be contained inside the battery can 11 having the cylindrical shape. A safety valve mechanism 30 may be attached to the battery can 11. The battery can 11 may be, for example, sealed by a battery cover 14. In an embodiment, the secondary battery 1 may further include one or more of components including, without limitation, a thermosensitive resistive device and a reinforcing member inside the battery can 11. Non-limiting examples of the thermosensitive resistive device may include a positive temperature coefficient (PTC) device.

The battery can 11 may correspond to a specific but non-limiting example of a "container" in an embodiment of the present disclosure. A structure including the battery cover 14 and the safety valve mechanism 30, which will be described later, may correspond to a specific but non-limiting example of a "cover part" in an embodiment of the present disclosure.

The battery can 11 may be a container having a hollow structure that extends in the Z direction, with a lower end part in the Z direction closed and an upper end part in the Z direction open. The upper end part of the battery can 11 in the Z direction may be an open end part 11N. The battery can 11 may include, for example, any one or more of metal materials including, without limitation, iron, aluminum, and alloys thereof. In an embodiment, the battery can 11 may have a surface plated with, for example, any one or more of metal materials including, without limitation, nickel.

Each of the insulating plates 12 and 13 may be, for example, a dish-shaped plate having a surface perpendicular to the central axis CP corresponding to a winding center of the battery device 20, e.g., a surface perpendicular to the Z direction in FIG. 1. The pair of insulating plates 12 and 13 may be so disposed as to allow the battery device 20 to be interposed therebetween in the Z direction and as to extend along a plane orthogonal to the Z direction.

The battery cover 14 and the safety valve mechanism 30 may be crimped at the open end part 11N of the battery can 11 with a gasket 15 interposed between the open end part 11N and both the battery cover 14 and the safety valve mechanism 30. The battery can 11 may thus be provided with a bent part 11P defining the open end part 11N.

The open end part 11N of the battery can 11 may be sealed by the battery cover 14 in a state where the battery device 20 and other components are contained inside the battery can 11. The battery can 11 may include a crimped structure 11R provided in the vicinity of the open end part 11N. The crimped structure 11R may be a structure in which the bent part 11P defining the open end part 11N and both the battery cover 14 and the safety valve mechanism 30 are crimped to each other with the gasket 15 interposed between the bent part 11P and both the battery cover 14 and the safety valve mechanism 30. A narrow part 11S may be provided between the bent part 11P and the insulating plate 12. The narrow part 11S may be a part of the battery can 11 that protrudes inward.

The battery cover 14 may be a cover member that closes the open end part 11N of the battery can 11. In an embodiment, the battery cover 14 may include a material similar to the material included in the battery can 11. In an embodiment, however, the battery cover 14 may include a material different from the material included in the battery can 11.

In an embodiment, the battery cover 14 may include stainless steel. One reason for this is that this secures physical strength of the battery cover 14 and accordingly secures physical strength of the crimped structure 11R, which helps to prevent easy detachment of the battery cover 14 and easy leakage of an electrolytic solution, which will be described later, even if an internal pressure of the battery can 11 increases. Non-limiting examples of the stainless steel may include SUS304 and SUS430.

The battery cover 14 may include a projecting part 14T in a middle region of the battery cover 14. The projecting part 14T may protrude, for example, upward, e.g., in a +Z direction. As a result, a peripheral region, i.e., a region other than the middle region, of the battery cover 14 may be in contact with the safety valve mechanism 30, for example. The projecting part 14T of the battery cover 14 may have a through hole H14. The presence of the through hole H14 helps to easily allow a third electrically conductive member 33 to cleave when a gas is generated inside the battery can 11 and the internal pressure of the battery can 11 increases, as will be described later. In an embodiment, the projecting part 14T may have one through hole H14 at only one location. In an embodiment, the projecting part 14T may have multiple through holes H14 at respective multiple locations.

The gasket 15 may be a sealing member that seals a gap between the bent part 11P and the battery cover 14. The gasket 15 may be interposed between the bent part 11P of the battery can 11 and the battery cover 14.

The gasket 15 may include any one or more of insulating materials. Non-limiting examples of the insulating materials may include a polymer material such as polybutylene terephthalate (PBT) or polypropylene (PP). One reason for this is that the gasket 15 including any one or more of the above-described insulating materials helps to allow for sufficient sealing of the gap between the bent part 11P and the battery cover 14, with the battery can 11 and the battery cover 14 being electrically separated from each other. The gasket 15 may correspond to a specific but non-limiting example of a "first insulating part" in an embodiment of the present disclosure.

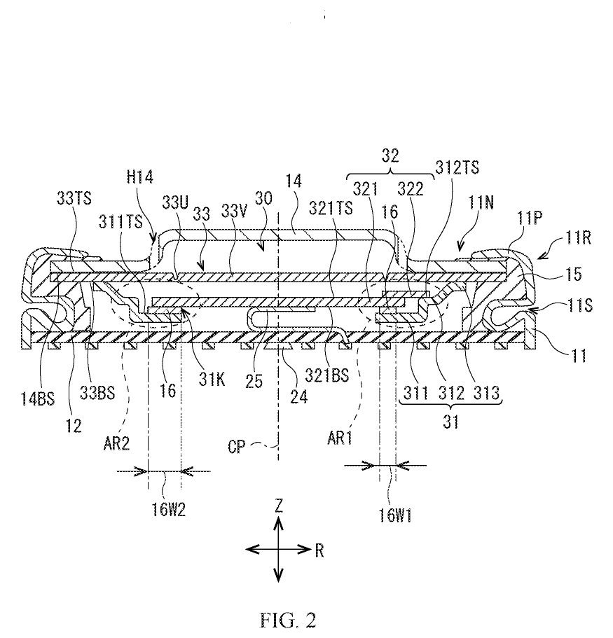

The safety valve mechanism 30 may be provided on an inner side of the battery cover 14 in the Z direction. The safety valve mechanism 30 may be a mechanism that, when the internal pressure of the battery can 11 increases, releases the internal pressure by unsealing the battery can 11 on an as-needed basis. Non-limiting examples of a cause of the increase in the internal pressure of the battery can 11 may include a gas generated due to a decomposition reaction of the electrolytic solution upon charging and discharging. The internal pressure of the battery can 11 can also increase due to heating from outside. An example detailed configuration of the safety valve mechanism 30 will be described later with reference to FIGS. 2, 3, and 5 to be described later.

The battery device 20 is contained inside the battery can 11. The battery device 20 may include a positive electrode 21, a negative electrode 22, and the electrolytic solution. The electrolytic solution may be a liquid electrolyte.

In the example illustrated in FIG. 1, the battery device 20 may be what is called a wound electrode body. That is, in the battery device 20, the positive electrode 21 and the negative electrode 22 may be stacked on each other with a separator 23 interposed therebetween, and the stack of the positive electrode 21, the negative electrode 22, and the separator 23 may be wound. The positive electrode 21, the negative electrode 22, and the separator 23 may each be impregnated with the electrolytic solution.

The battery device 20 may have, at the center thereof, a space resulting from winding the positive electrode 21, the negative electrode 22, and the separator 23. The space may be referred to as a center space 20C. A center pin 24 may be disposed in the center space 20C. In an embodiment, however, the center pin 24 may be omitted.

A positive electrode lead 25 may be coupled to the positive electrode 21. A negative electrode lead 26 may be coupled to the negative electrode 22. The positive electrode lead 25 may include any one or more of electrically conductive materials including, without limitation, a metal material. Non-limiting examples of the metal material included in the positive electrode lead 25 may include aluminum. The positive electrode lead 25 may be electrically coupled to the battery cover 14 via the safety valve mechanism 30. The negative electrode lead 26 may include any one or more of electrically conductive materials including, without limitation, a metal material. Non-limiting examples of the metal material included in the negative electrode lead 26 may include nickel. The negative electrode lead 26 may be electrically coupled to the battery can 11.

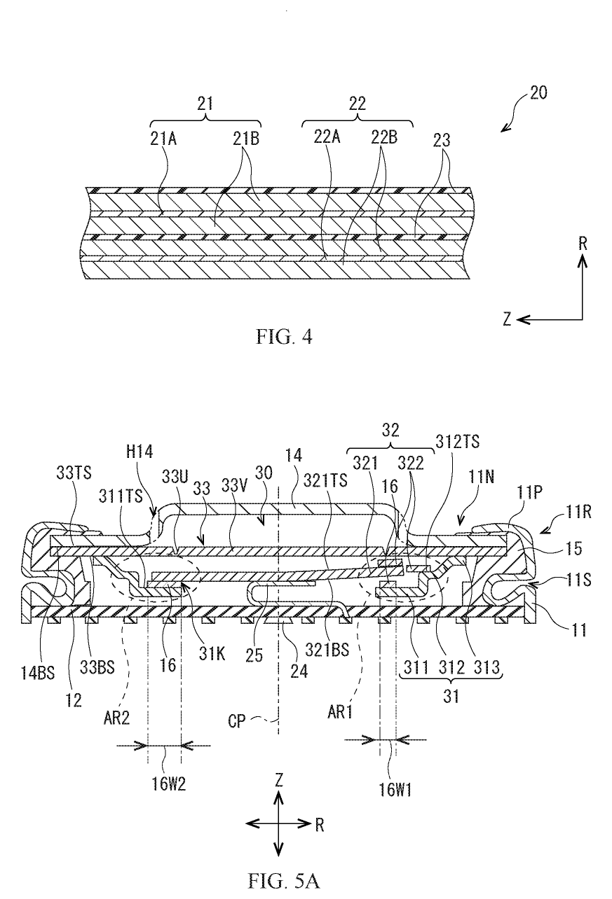

An example detailed configuration of the battery device 20, i.e., an example detailed configuration of each of the positive electrode 21, the negative electrode 22, the separator 23, and the electrolytic solution will be described later with reference to FIG. 4.

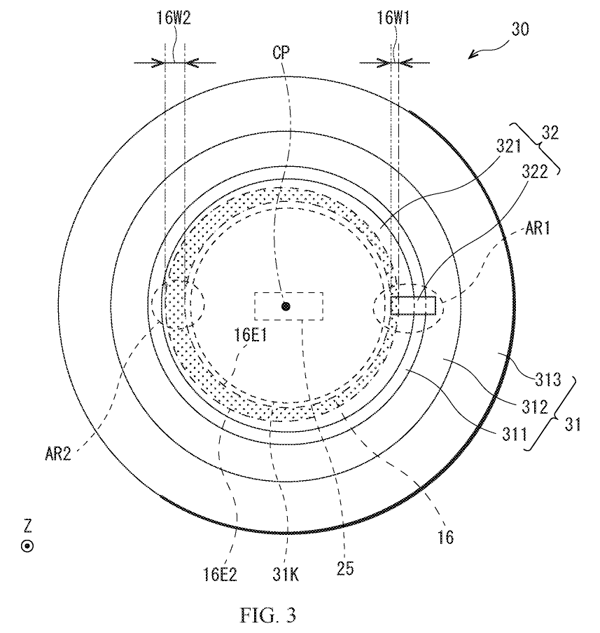

FIG. 2 illustrates a part of a sectional configuration of the secondary battery 1 illustrated in FIG. 1, and more specifically, illustrates the safety valve mechanism 30 and the vicinity thereof. FIG. 3 is a plan diagram illustrating, in an enlarged manner, a configuration example of the safety valve mechanism 30.

As illustrated in FIGS. 2 and 3, the safety valve mechanism 30 may include a first electrically conductive member 31, a second electrically conductive member 32, a third electrically conductive member 33, and a sealing part 16. Note that FIG. 3 omits illustration of the third electrically conductive member 33. The first electrically conductive member 31 may correspond to a specific but non-limiting example of a "first electrically conductive member" in an embodiment of the present disclosure. The second electrically conductive member 32 may correspond to a specific but non-limiting example of a "second electrically conductive member" in an embodiment of the present disclosure. The sealing part 16 may correspond to a specific but non-limiting example of a "second insulating part" in an embodiment of the present disclosure.

The third electrically conductive member 33 may be, for example, a metal member having a circular plate shape that expands along a horizontal plane orthogonal to the Z direction and has a center corresponding to the central axis CP. The third electrically conductive member 33 may include an upper surface 33TS and a lower surface 33BS. The upper surface 33TS may face the battery cover 14. The lower surface 33BS may be opposite to the upper surface 33TS. The upper surface 33TS of the third electrically conductive member 33 may abut against a lower surface 14BS of the battery cover 14. The third electrically conductive member 33 may be cleavable in part, in response to an increase in the internal pressure of the battery can 11. As illustrated in FIG. 2, the third electrically conductive member 33 may include a valve part 33V in a middle region of the safety valve mechanism 30. The valve part 33V may be cleavable in response to an increase in the internal pressure of the battery can 11. The third electrically conductive member 33 may include a grooved part 33U that surrounds the valve part 33V and has an annular shape in a plan view. For example, the valve part 33V may be defined by the grooved part 33U. In an embodiment, when the third electrically conductive member 33 cleaves, the grooved part 33U may break in part and thus cause the valve part 33V to cleave in part. In an embodiment, when the third electrically conductive member 33 cleaves, the entire grooved part 33U may break and thus cause the entire valve part 33V to cleave. The third electrically conductive member 33 may include any one or more of electrically conductive materials including, without limitation, a metal material. Non-limiting examples of the metal material may include aluminum and an aluminum alloy. A plan shape of the third electrically conductive member 33 is not particularly limited, and non-limiting examples thereof may include a circular shape. As used herein, the term "plan shape" may refer to a shape along a horizontal plane orthogonal to the Z direction. This definition of the plan shape may be similarly applicable in the description below. In an embodiment, the third electrically conductive member 33 may include a step structure as with the first electrically conductive member 31 to be described later.

The first electrically conductive member 31 may be, for example, an annular-shaped member that is so provided to surround the central axis CP along a horizontal plane orthogonal to the Z direction, as illustrated in FIG. 3. The first electrically conductive member 31 has an opening 31K. The opening 31K may be at a position overlapping the center space 20C of the battery device 20 in the Z direction, and may extend through the first electrically conductive member 31 in the Z direction. The opening 31K may be a vent adapted to release the gas generated inside the battery can 11 to an outside. A plan shape of the opening 31K is not particularly limited, and non-limiting examples thereof may include a circular shape. The first electrically conductive member 31 may include a step structure. The step structure may include, for example, a first tread part 311, a second tread part 312, and a flange part 313 that are disposed in the R direction, in this order from a position close to the central axis CP. The first tread part 311, the second tread part 312, and the flange part 313 may each have an annular shape in a plan view. In the example illustrated in FIG. 3, a center position of each of the first tread part 311, the second tread part 312, and the flange part 313 may coincide with a position of the central axis CP. The first tread part 311 may include an upper surface 311TS that includes a part extending in parallel to a horizontal plane orthogonal to the Z direction, as illustrated in FIG. 2. The second tread part 312 may include an upper surface 312TS that includes a part extending in parallel to a horizontal plane orthogonal to the Z direction, as illustrated in FIG. 2. The flange part 313 may include an upper surface that is joined to the lower surface 33BS of the third electrically conductive member 33, as illustrated in FIG. 2. The first electrically conductive member 31 may include, for example, any one or more of metal materials. Non-limiting examples of the metal materials may include a simple substance of iron, a simple substance of aluminum, and an alloy including iron, aluminum, or both.

In an embodiment, the second electrically conductive member 32 may include a body part 321 and a coupling part 322. The body part 321 may be, for example, a circular-plate-shaped member provided at a position that overlaps the opening 31K in the Z direction, as illustrated in FIG. 3. For example, the body part 321 of the second electrically conductive member 32 may be so provided as to cover the opening 31K of the first electrically conductive member 31. The body part 321 may have a peripheral part that overlaps, in the Z direction, a part, of the first electrically conductive member 31, near the opening 31K, and is attached to the first electrically conductive member 31 via the sealing part 16. For example, the peripheral part of the body part 321 may be so disposed as to be opposed to a part of the upper surface 311TS of the first tread part 311 with the sealing part 16 interposed therebetween, and the peripheral part of the body part 321 and a part of the upper surface 311TS of the first tread part 311 may be joined to each other via the sealing part 16. The coupling part 322 may include, for example, a metal foil having a strip shape. Accordingly, in an embodiment, a thickness of the coupling part 322 may be smaller than a thickness of the body part 321. The coupling part 322 may be joined to each of an upper surface 321TS of the body part 321 and the upper surface 312TS of the second tread part 312. The body part 321 and the coupling part 322 may each include, for example, any one or more of metal materials. Non-limiting examples of the metal materials may include a simple substance of iron, a simple substance of aluminum, and an alloy including iron, aluminum, or both. The body part 321 and the coupling part 322 may include respective materials that are the same as each other in kind or different from each other in kind. The sealing part 16 may have an annular shape and may be so provided as to surround the opening 31K in a plan view, as illustrated in FIG. 3. The sealing part 16 may include, for example, a thermoplastic insulating resin such as polypropylene or polyethylene. The body part 321 of the second electrically conductive member 32 may be coupled to the positive electrode lead 25 through the opening 31K.

As illustrated in FIGS. 2 and 3, the safety valve mechanism 30 includes a first joining region AR1 and a second joining region AR2 in each of which the first electrically conductive member 31 and the second electrically conductive member 32 are mechanically joined to each other. The first joining region AR1 may be, for example, on an opposite side of the central axis CP to the second joining region AR2 in the radial direction, e.g., the R direction. In the first joining region AR1, the first electrically conductive member 31 and the second electrically conductive member 32 are electrically coupled to each other. In the second joining region AR2, the first electrically conductive member 31 and the second electrically conductive member 32 are electrically insulated from each other. In an embodiment, in the first joining region AR1, the body part 321 may be electrically coupled to and mechanically joined to the first electrically conductive member 31 via the coupling part 322. For example, the upper surface 321TS of the body part 321 may be electrically coupled to and mechanically joined to the coupling part 322, and the upper surface 312TS of the second tread part 312 of the first electrically conductive member 31 may be electrically coupled to and mechanically joined to the coupling part 322. The upper surface 321TS of the body part 321 and the coupling part 322 may be joined to each other by, for example, a method such as laser welding, ultrasonic welding, or resistance welding. The upper surface 312TS of the second tread part 312 of the first electrically conductive member 31 and the coupling part 322 may also be joined to each other by, for example, a method such as laser welding, ultrasonic welding, or resistance welding. In an embodiment, in the first joining region AR1, a lower surface 321BS of the body part 321 may be mechanically joined to the upper surface 311TS of the first tread part 311 via the sealing part 16. In an embodiment, in the second joining region AR2 also, the lower surface 321BS of the body part 321 may be mechanically joined to the upper surface 311TS of the first tread part 311 via the sealing part 16. Here, the lower surface 321BS of the body part 321 and the sealing part 16 may be joined to each other by, for example, thermal welding or adhesion using an adhesive.

In the safety valve mechanism 30, a second joining strength with which the first electrically conductive member 31 and the second electrically conductive member 32 are joined to each other in the second joining region AR2 is higher than a first joining strength with which the first electrically conductive member 31 and the second electrically conductive member 32 are joined to each other in the first joining region AR1. As used herein, the first joining strength may refer to the highest strength among four strengths, i.e., a joining strength with which the body part 321 and the coupling part 322 are joined to each other, a joining strength with which the second tread part 312 and the coupling part 322 are joined to each other, a joining strength with which the body part 321 and the first tread part 311 are joined to each other, and a breakage strength of the coupling part 322. In the present example embodiment, the joining strength with which the body part 321 and the first tread part 311 are joined to each other may be the highest strength among the four strengths. Therefore, when external force that causes the body part 321 to be detached from the first tread part 311 is applied to the first joining region AR1, at least one of detachment of the coupling part 322 from the body part 321, detachment of the coupling part 322 from the second tread part 312, or breakage of the coupling part 322 may occur in the first joining region AR1. The joining strength may be determined by measuring pressing force per unit area when the sealing part 16 is caused to cleave by pressing the body part 321 in the +Z direction, e.g., a direction from a bottom part of the battery can 11 of the secondary battery 1 toward the open end part 11N, or an upward direction. For example, the joining strength may be calculated by dividing the pressing force against the body part 321 upon cleavage of the sealing part 16 by an area of a part in which the sealing part 16 and the body part 321 overlap each other. In addition, it may be possible to identify a part having a relatively low joining strength and a part having a relatively high joining strength by checking which part of the sealing part 16 in a circumferential direction has cleaved. In the secondary battery 1 according to the present example embodiment, the first joining strength of a part, of the sealing part 16, occupying the first joining region AR1 may be lower than the second joining strength of a part, of the sealing part 16, occupying the second joining region AR2. This causes the sealing part 16 to cleave in the first joining region AR1. Further, in the present example embodiment, a width 16W2 of the sealing part 16 in the second joining region AR2 may be larger than a width 16W1 of the sealing part 16 in the first joining region AR1, in the radial direction, e.g., the R direction, orthogonal to the Z direction, as illustrated in FIGS. 1 to 3. Therefore, the joining strength with which the body part 321 and the first tread part 311 are joined to each other via the sealing part 16 in the second joining region AR2 may be higher than the joining strength with which the body part 321 and the first tread part 311 are joined to each other via the sealing part 16 in the first joining region AR1. In the present example embodiment, as illustrated in FIG. 3, for example, a center position of an inner edge 16E1 of a circular shape of the sealing part 16 may be different from a center position of an outer edge 16E2 of the circular shape of the sealing part 16. In the example illustrated in FIG. 3, the center position of the inner edge 16E1 of the circular shape of the sealing part 16 may coincide or substantially coincide with the position of the central axis CP, while the center position of the outer edge 16E2 of the circular shape of the sealing part 16 may be deviated from the position of the central axis CP in a left direction on the paper plane. In addition, for example, a center position of the body part 321 and a center position of the opening 31K may coincide or substantially coincide with the position of the central axis CP. Therefore, the width 16W1 of the sealing part 16 in the first joining region AR1 may be the smallest of a width 16W of the sealing part 16 in all regions in the radial direction, e.g., the R direction, orthogonal to the Z direction, as illustrated in FIGS. 1 to 3. Accordingly, the joining strength with which the body part 321 and the first tread part 311 are joined to each other via the sealing part 16 in the first joining region AR1 may be lower than the joining strength with which the body part 321 and the first tread part 311 are joined to each other via the sealing part 16 in a region other than the first joining region AR1. As a result, for example, when biasing force is applied to the body part 321 in the +Z direction due to an increase in pressure inside the battery can 11, detachment of the body part 321 from the first tread part 311 of the first electrically conductive member 31 may occur first in the first joining region AR1.

FIG. 4 illustrates, in an enlarged manner, a part of a sectional configuration of the battery device 20 illustrated in FIG. 1. The battery device 20 may include the positive electrode 21, the negative electrode 22, the separator 23, and the electrolytic solution, as described above.

The positive electrode 21 may include, as illustrated in FIG. 4, a positive electrode current collector 21A and a positive electrode active material layer 21B.

The positive electrode current collector 21A may have two opposed surfaces on each of which the positive electrode active material layer 21B is to be provided. The positive electrode current collector 21A may include an electrically conductive material such as a metal material. Non-limiting examples of the metal material may include aluminum.

In an example illustrated in FIG. 4, the positive electrode active material layer 21B may be provided on each of the two opposed surfaces of the positive electrode current collector 21A. The positive electrode active material layer 21B may include any one or more of positive electrode active materials which lithium is insertable into and extractable from. Note that, in an embodiment, the positive electrode active material layer 21B may be provided simply on one of the two opposed surfaces of the positive electrode current collector 21A, on a side on which the positive electrode 21 is opposed to the negative electrode 22. In an embodiment, the positive electrode active material layer 21B may further include materials including, without limitation, a positive electrode binder and a positive electrode conductor. A method of forming the positive electrode active material layer 21B is not particularly limited, and may be, for example, a method such as a coating method.

The positive electrode active material may include a lithium compound. The lithium compound may be a compound including lithium as a constituent element, and may be, for example, a compound including lithium and one or more transition metal elements as constituent elements. One reason for this is that this helps to obtain a high energy density. Note that, in an embodiment, the lithium compound may further include any one or more of other elements, e.g., elements other than lithium and the transition metal elements.

The lithium compound is not particularly limited in kind, and non-limiting examples thereof may include a lithium composite oxide having a layered rock-salt crystal structure, a lithium composite oxide having a spinel crystal structure, and a lithium phosphoric acid compound having an olivine crystal structure. Non-limiting examples of the lithium composite oxide having the layered rock-salt crystal structure may include LiNiO₂, LiNi_{0.8}Co_{0.15}Al_{0.05}, and LiCoO₂. Non-limiting examples of the lithium composite oxide having the spinel crystal structure may include LiMn₂O₄. Non-limiting examples of the lithium phosphoric acid compound having the olivine crystal structure may include LiFePO₄ and LiMnPO₄.

In an embodiment, the positive electrode active material may include the lithium phosphoric acid compound having the olivine crystal structure. One reason for this is that, because the crystal structure of the lithium phosphoric acid compound having the olivine crystal structure is thermally stable, this helps to prevent the secondary battery 1 from easily exhibiting thermal runaway due to a cause such as overcharging or an internal short circuit. Another reason is that, because the crystal structure of the lithium phosphoric acid compound having the olivine crystal structure is firm, this helps to prevent the battery capacity from decreasing easily even if the secondary battery 1 is charged and discharged repeatedly.

The positive electrode binder may include any one or more of materials including, without limitation, a synthetic rubber and a polymer compound. Non-limiting examples of the synthetic rubber may include a styrene-butadiene-based rubber. Non-limiting examples of the polymer compound may include polyvinylidene difluoride.

The positive electrode conductor may include any one or more of electrically conductive materials including, without limitation, a carbon material. Non-limiting examples of the carbon material may include graphite, carbon black, acetylene black, and Ketjen black. Note that, in an embodiment, the electrically conductive material may be a metal material or a polymer compound, for example.

The negative electrode 22 may include, as illustrated in FIG. 4, a negative electrode current collector 22A and a negative electrode active material layer 22B.

The negative electrode current collector 22A may have two opposed surfaces on each of which the negative electrode active material layer 22B is to be provided. The negative electrode current collector 22A may include an electrically conductive material such as a metal material. Non-limiting examples of the metal material may include copper.

Here, the negative electrode active material layer 22B may be provided on each of the two opposed surfaces of the negative electrode current collector 22A, and may include any one or more of negative electrode active materials which lithium is insertable into and extractable from. Note that in an embodiment, the negative electrode active material layer 22B may be provided simply on one of the two opposed surfaces of the negative electrode current collector 22A, on a side on which the negative electrode 22 is opposed to the positive electrode 21. In an embodiment, the negative electrode active material layer 22B may further include materials including, without limitation, a negative electrode binder and a negative electrode conductor. Details of the negative electrode binder may be similar to those of the positive electrode binder. Details of the negative electrode conductor may be similar to those of the positive electrode conductor. A method of forming the negative electrode active material layer 22B is not particularly limited, and may include, for example, any one or more of methods including, without limitation, a coating method, a vapor-phase method, a liquid-phase method, a thermal spraying method, and a firing or sintering method.

The negative electrode active material may include a carbon material, a metal-based material, or both, for example. One reason for this is that this helps to obtain a high energy density. Non-limiting examples of the carbon material may include graphitizable carbon, non-graphitizable carbon, and graphite such as natural graphite or artificial graphite. The metal-based material may be a material that includes, as one or more constituent elements, any one or more elements among metal elements and metalloid elements that are each able to form an alloy with lithium. Non-limiting examples of such metal elements and metalloid elements may include silicon, tin, or both. Note that in an embodiment, the metal-based material may be a simple substance, an alloy, a compound, a mixture of two or more thereof, or a material including two or more phases thereof. Non-limiting examples of the metal-based material may include TiSi₂ and SiOₓ (0 < x ≤ 2 or 0.2 < x < 1.4).

The separator 23 may be an insulating porous film interposed between the positive electrode 21 and the negative electrode 22 as illustrated in FIG. 4. The separator 23 may allow lithium ions to pass therethrough and may prevent a short circuit between the positive electrode 21 and the negative electrode 22. The separator 23 may include a polymer compound such as polyethylene.

The electrolytic solution may include a solvent and an electrolyte salt. The solvent may include any one or more of non-aqueous solvents, or organic solvents, including, without limitation, a carbonic-acid-ester-based compound, a carboxylic-acid-ester-based compound, and a lactone-based compound. An electrolytic solution including any of the non-aqueous solvents may be what is called a non-aqueous electrolytic solution. In an embodiment, however, the solvent may be an aqueous solvent. The electrolyte salt may include any one or more of light metal salts including, without limitation, a lithium salt. A content of the electrolyte salt is not particularly limited. In an embodiment, the content of the electrolyte salt may be within a range from 0.3 mol/kg to 3 mol/kg both inclusive with respect to the solvent. One reason for this is that this helps to obtain high ion conductivity.

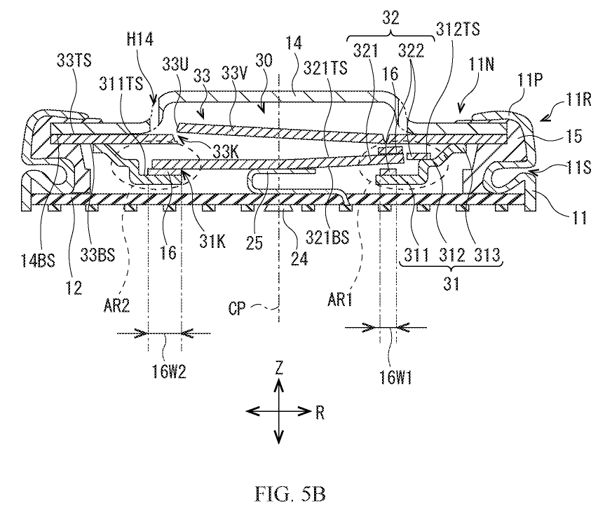

FIGS. 5A and 5B are each an explanatory diagram describing an operation of the secondary battery 1 of the present example embodiment, for example, behavior of the secondary battery 1 at a time when the internal pressure increases, and illustrating a sectional configuration corresponding to FIG. 2. In the following, an operation at the time of charging and discharging will be described, and thereafter, the operation at the time when the internal pressure increases will be described. Here, reference is also made to FIG. 2 in addition to FIG. 5 where appropriate.

Upon charging, in the battery device 20, lithium may be extracted from the positive electrode 21, and the extracted lithium may be inserted into the negative electrode 22 via the electrolytic solution. Upon discharging, in the battery device 20, lithium may be extracted from the negative electrode 22, and the extracted lithium may be inserted into the positive electrode 21 via the electrolytic solution. Upon the charging and discharging, lithium may be inserted and extracted in an ionic state.

Upon charging and discharging of the secondary battery 1, when the internal pressure of the battery can 11 increases, the safety valve mechanism 30 may operate in order to prevent, for example, rupture or damage of the secondary battery 1 from easily occurring. In the secondary battery 1 according to the present example embodiment, a current path from the battery device 20 to the battery cover 14 may be configured to be cut off by generation of a gap between the first electrically conductive member 31 and the second electrically conductive member 32 in the safety valve mechanism 30, caused by an increase in internal pressure of the battery can 11 containing the battery device 20.

For example, when the secondary battery 1 is operating normally, in the first joining region AR1, the body part 321 may be joined to the first tread part 311 via the sealing part 16, and may be electrically continuous with the second tread part 312 via the coupling part 322, as illustrated in FIG. 2. The opening 31K of the first electrically conductive member 31 may thus be closed by the second electrically conductive member 32.

In contrast, when a gas is generated inside the battery can 11 due to a side reaction such as the decomposition reaction of the electrolytic solution, the generated gas may be accumulated in a space inside the battery can 11, e.g., a space sealed by the battery can 11 and the safety valve mechanism 30, causing the internal pressure of the battery can 11 to increase. Here, when the internal pressure of the battery can 11 reaches a certain level or higher, the sealing part 16, which seals the body part 321 and the first tread part 311, may so cleave in part, that the body part 321 is separated from the first tread part 311 in the first joining region AR1, as illustrated in FIG. 5A. This may allow the space inside the battery can 11 and a space between the first electrically conductive member 31 and the third electrically conductive member 33 of the safety valve mechanism 30 to be continuous through the opening 31K. At this time, a part of the body part 321 may be separated from the sealing part 16, and the coupling part 322 may break at the same time or at substantially the same time in the first joining region AR1. This may cut off the electrical continuity between the body part 321 coupled to the positive electrode lead 25, and the first electrically conductive member 31, and may thus cut off the current path inside the secondary battery 1. As a result, a battery reaction may stop. In addition, when the internal pressure of the battery can 11 increases, a part of the grooved part 33U of the third electrically conductive member 33 may break, and the valve part 33V may thus cleave in part, as illustrated in FIG. 5B. This may provide an opening 33K in the third electrically conductive member 33, and may thus open a gas releasing path using the openings 31K and 33K and the through hole H14. As a result, the gas generated inside the battery can 11 may be released to the outside of the secondary battery 1 via the openings 31K and 33K and the through hole H14.

Note that when the internal pressure of the secondary battery 1 further increases, the bent part 11P may be deformed, and the crimped structure 11R may therefore break. As a result, the battery cover 14 may be detached from the battery can 11, and the gas may thus be released to the outside of the secondary battery 1.

First, the positive electrode active material may be mixed with materials including, without limitation, the positive electrode binder and the positive electrode conductor on an as-needed basis to thereby obtain a positive electrode mixture. Thereafter, the positive electrode mixture may be dispersed in a solvent to thereby obtain a positive electrode mixture slurry in paste form. The solvent is not particularly limited in kind, and may be an aqueous solvent or a non-aqueous solvent, e.g., an organic solvent. Thereafter, the positive electrode mixture slurry may be applied on the two opposed surfaces of the positive electrode current collector 21A to thereby form the positive electrode active material layers 21B. Thereafter, the positive electrode active material layers 21B may be compression-molded using, for example, a roll pressing machine. In an embodiment, the positive electrode active material layers 21B may be heated. In an embodiment, the positive electrode active material layers 21B may be compression-molded multiple times. The positive electrode active material layers 21B may thus be formed on the respective two opposed surfaces of the positive electrode current collector 21A. As a result, the positive electrode 21 may be fabricated.

The negative electrode active material layers 22B may be formed on the respective two opposed surfaces of the negative electrode current collector 22A by a procedure similar to that of the positive electrode 21 described above. For example, the negative electrode active material may be mixed with materials including, without limitation, the negative electrode binder and the negative electrode conductor to thereby obtain a negative electrode mixture. Thereafter, the negative electrode mixture may be dispersed in a solvent to thereby obtain a negative electrode mixture slurry in paste form. Details of the solvent may be as described above. Thereafter, the negative electrode mixture slurry may be applied on the two opposed surfaces of the negative electrode current collector 22A to thereby form the negative electrode active material layers 22B. Thereafter, the negative electrode active material layers 22B may be compression-molded using, for example, a roll pressing machine. Details of compression molding may be as described above. The negative electrode active material layers 22B may thus be formed on the respective two opposed surfaces of the negative electrode current collector 22A. As a result, the negative electrode 22 may be fabricated.

First, the positive electrode lead 25 may be coupled to the positive electrode current collector 21A of the positive electrode 21 by a method such as a welding method. In a similar manner, the negative electrode lead 26 may be coupled to the negative electrode current collector 22A of the negative electrode 22 by a method such as a welding method. Thereafter, the positive electrode 21 and the negative electrode 22 may be stacked on each other with the separator 23 interposed therebetween to form a stacked body, following which the obtained stacked body may be wound to thereby form a wound body having the center space 20C. The wound body may have a configuration similar to that of the battery device 20 except that the positive electrode 21, the negative electrode 22, and the separator 23 are each not impregnated with the electrolytic solution. Thereafter, the center pin 24 may be placed in the center space 20C of the wound body.

Thereafter, the battery can 11 may be prepared, following which the insulating plates 12 and 13 may be opposed to each other with the wound body interposed therebetween, and the wound body, together with the insulating plates 12 and 13, may be placed inside the battery can 11. In this case, the positive electrode lead 25 may be coupled to the safety valve mechanism 30 by a method such as a welding method, and the negative electrode lead 26 may be coupled to the battery can 11 by a method such as a welding method.

Thereafter, the electrolytic solution may be injected into the battery can 11 to thereby impregnate the wound body with the electrolytic solution. Thus, the positive electrode 21, the negative electrode 22, and the separator 23 may each be impregnated with the electrolytic solution, and the battery device 20 may be fabricated. Thereafter, the battery cover 14 and the safety valve mechanism 30 may be placed inside the battery can 11 together with the gasket 15. Note that regarding the safety valve mechanism 30, a structure in which the second electrically conductive member 32 is joined to the first electrically conductive member 31 via the sealing part 16, as illustrated in FIG. 2 and the like, may be prepared in advance.

Thereafter, the open end part 11N of the battery can 11 and both the battery cover 14 and the safety valve mechanism 30 may be crimped to each other with the gasket 15 interposed between the open end part 11N and both the battery cover 14 and the safety valve mechanism 30 at the open end part 11N, as illustrated in FIG. 1. The bent part 11P may thus be formed, and the crimped structure 11R may thereby be formed. As a result, the battery can 11 may be closed by the battery cover 14 to finish the assembly of the secondary battery 1.

The assembled secondary battery 1 may be charged and discharged. Various conditions including, for example, an environment temperature, the number of times of charging and discharging (the number of cycles), and charging and discharging conditions may be set as desired. A film may thus be formed on a location such as a location on a surface of the negative electrode 22. This may bring the secondary battery 1 into an electrochemically stable state. As a result, the secondary battery 1 of the cylindrical type may be completed in which the battery device 20 and other components are sealed inside the battery can 11.

In the secondary battery 1 according to the present example embodiment, the current path from the battery device 20 to the battery cover 14 may be configured to be cut off by generation of a gap between the first electrically conductive member 31 and the second electrically conductive member 32 in the safety valve mechanism 30, caused by an increase in internal pressure of the battery can 11 containing the battery device 20. The safety valve mechanism 30 includes the first joining region AR1 and the second joining region AR2 in each of which the first electrically conductive member 31 and the second electrically conductive member 32 are mechanically joined to each other. In the first joining region AR1, the first electrically conductive member 31 and the second electrically conductive member 32 are electrically coupled to each other. In the second joining region AR2, the first electrically conductive member 31 and the second electrically conductive member 32 are electrically insulated from each other. Here, the second joining strength with which the first electrically conductive member 31 and the second electrically conductive member 32 are joined to each other in the second joining region AR2 is higher than the first joining strength with which the first electrically conductive member 31 and the second electrically conductive member 32 are joined to each other in the first joining region AR1. Therefore, according to the secondary battery 1 of the present example embodiment, when the pressure inside the battery can 11 reaches a predetermined value or higher due to gas generation, the mechanical joining between the first electrically conductive member 31 and the second electrically conductive member 32 in the first joining region AR1 may be cut off, and the electrical coupling between the first electrically conductive member 31 and the second electrically conductive member 32 in the first joining region AR1 may also be cut off. Accordingly, the current path provided from the battery device 20 to the first electrically conductive member 31 via the second electrically conductive member 32 may be cut off. This helps to stop proceeding of the battery reaction, and thus helps to secure safety.

In the secondary battery 1 according to the present example embodiment, the sealing part 16 including a material such as the insulating resin may seal the internal space of the battery can 11 that contains the battery device 20 including the electrolytic solution. Thus, the secondary battery 1 according to the present example embodiment does not have a structure in which the coupling part 322 is used to seal the internal space of the battery can 11 containing the battery device 20. This may allow the coupling part 322 to include a metal foil having a small thickness.

In contrast, for example, in JP-A No. 2006-128131, when an internal pressure of a battery can increases, a gas releasing path is secured and a current path is cut off by causing a metal plate to deform. However, deforming of the metal plate requires a relatively high pressure. In view of safety of the battery, it may be desirable to stop a battery reaction when the internal pressure of the battery can is smaller. This may be achieved by reducing the thickness of the metal plate. However, work-hardening of the metal plate caused through processing of reducing the thickness of the metal plate can make it difficult to deform the metal plate. In addition, the work-hardening of the metal plate caused through the processing of reducing the thickness of the metal plate can increase brittleness of the metal plate. This can more easily cause the metal plate to crack when an impact is applied to the secondary battery through normal use. JP-A No. 2006-128131 described above employs a structure in which the internal space of the battery can is sealed by such a metal plate. Therefore, when the metal plate cracks, although the current path is not cut off, the electrolytic solution can leak into an unintended region. Therefore, in the secondary battery of JP-A No. 2006-128131 described above, a setting value of the internal pressure at which the current path is to be cut off may have to be set relatively high.

In the secondary battery 1 according to the present example embodiment, the coupling part 322 that contributes to cutting off of the current path and the body part 321 that contributes to sealing of the internal space of the battery can 11 may be individually provided in the first joining region AR1. In the secondary battery 1 according to the present example embodiment, for example, breaking of the coupling part 322 may cut off the current path, and partial cutting off of the joining of the body part 321 and the second electrically conductive member 32 via the sealing part 16 may form the gas releasing path. Therefore, even if a crack may occur for some reason due to reduction in the thickness of the coupling part 322, the electrolytic solution is prevented from leaking into a region other than a predetermined region. In addition, selecting a physical property of the insulating resin material included in the sealing part 16 may allow for adjustment of the strength with which the body part 321 and the second electrically conductive member 32 are joined to each other via the sealing part 16. Therefore, in the secondary battery 1 according to the present example embodiment, a setting value of the internal pressure at which the current path is to be cut off may be set independently of the physical property of the coupling part 322. Therefore, as compared with the secondary battery of JP-A No. 2006-128131 described above, the secondary battery 1 according to the present example embodiment helps to lower the setting value of the internal pressure at which the current path is to be cut off. Accordingly, for example, the secondary battery 1 of the present example embodiment helps to stop the battery reaction when the internal pressure of the battery can is smaller, and to thus improve safety.

The configuration of the secondary battery 1 may be appropriately modified as described below according to an embodiment. Note that any two or more of the following series of modification examples may be combined with each other.

FIG. 6 is a plan diagram illustrating a configuration example of a safety valve mechanism 30A according to a first modification example (Modification example 1-1) of the first example embodiment. In the example embodiment described above, as illustrated in FIG. 3, for example, the width 16W1 of the sealing part 16 in the first joining region AR1 may be made smaller than the width 16W2 of the sealing part 16 in the second joining region AR2 by causing the center position of the inner edge 16E1 of the circular shape of the sealing part 16 to be different from the center position of the outer edge 16E2 of the circular shape of the sealing part 16. The secondary battery according to one example embodiment, however, may employ the safety valve mechanism 30A illustrated in FIG. 6. In the safety valve mechanism 30A illustrated in FIG. 6, the center position of the inner edge 16E1 of the circular shape of the sealing part 16 and the center position of the outer edge 16E2 of the circular shape of the sealing part 16 may both coincide or substantially coincide with the position of the central axis CP in a plan view. In addition, the sealing part 16 of the safety valve mechanism 30A may include a cutout part 16C at a part corresponding to the first joining region AR1. In the safety valve mechanism 30A, this may allow the width 16W1 of the sealing part 16 in the first joining region AR1 to be smaller than the width 16W2 of the sealing part 16 in the second joining region AR2, as with the safety valve mechanism 30 of the first example embodiment illustrated in FIG. 3. Accordingly, the joining strength with which the body part 321 and the first tread part 311 are joined to each other via the sealing part 16 in the first joining region AR1 may be lower than the joining strength with which the body part 321 and the first tread part 311 are joined to each other via the sealing part 16 in a region other than the first joining region AR1. As a result, a secondary battery including the safety valve mechanism 30A helps to achieve effects similar to those achieved by the secondary battery 1 including the safety valve mechanism 30 in the first example embodiment described above.

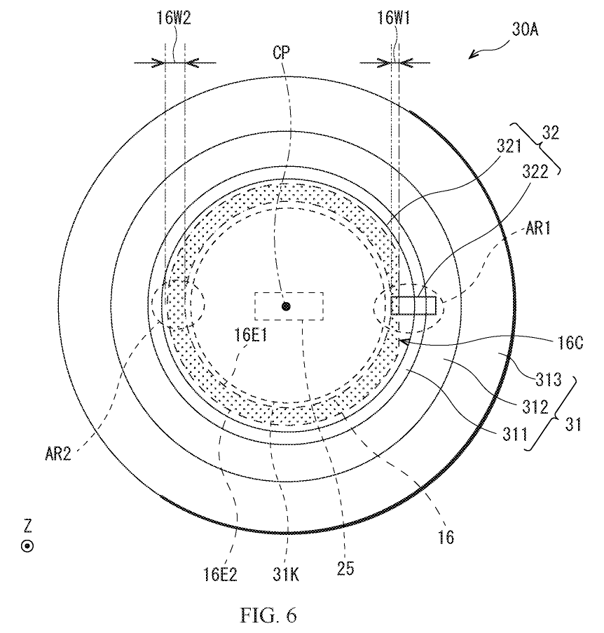

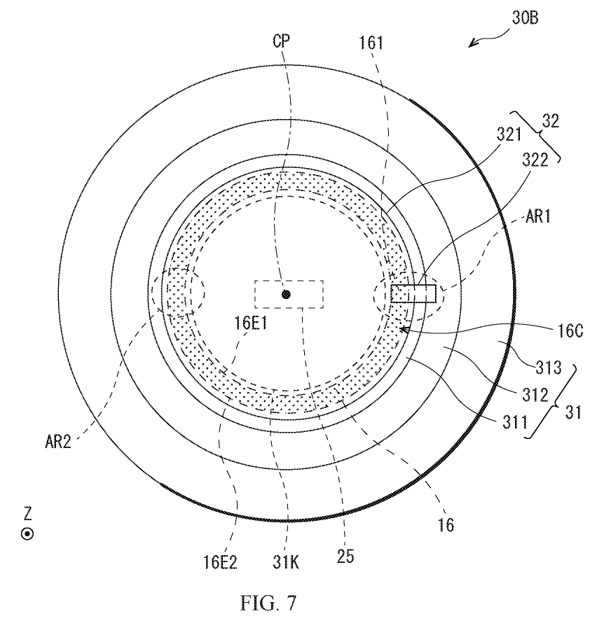

FIG. 7 is a plan diagram illustrating a configuration example of a safety valve mechanism 30B according to a second modification example (Modification example 1-2) of the first example embodiment. In the safety valve mechanism 30 of the example embodiment described above, all parts of the sealing part 16 may include the same kind of material. In contrast, in the safety valve mechanism 30B illustrated in FIG. 7, a joining strength of a first part 161, of the sealing part 16, corresponding to the first joining region AR1 may be lower than a joining strength of a part, of the sealing part 16, other than the first part 161. In a manufacturing process, the first part 161 having a relatively low joining strength may be formed by, for example, selectively changing a condition such as a heating temperature or an applied pressure for the sealing part 16 in joining the body part 321 and the first tread part 311 to each other. In the safety valve mechanism 30B also, the joining strength with which the body part 321 and the first tread part 311 are joined to each other via the sealing part 16 in the first joining region AR1 may be lower than the joining strength with which the body part 321 and the first tread part 311 are joined to each other via the sealing part 16 in a region other than the first joining region AR1. As a result, a secondary battery including the safety valve mechanism 30B helps to achieve effects similar to those achieved by the secondary battery 1 including the safety valve mechanism 30 in the first example embodiment described above.

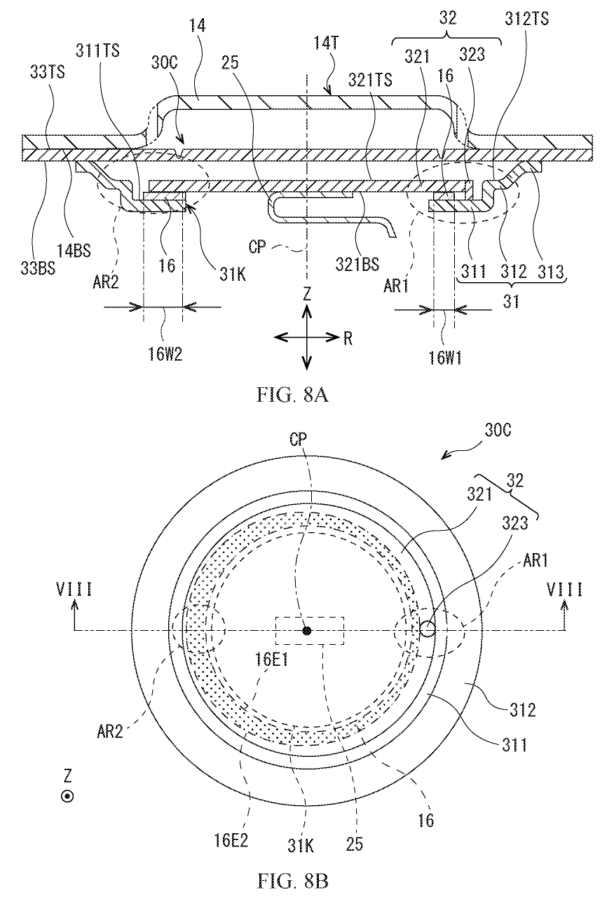

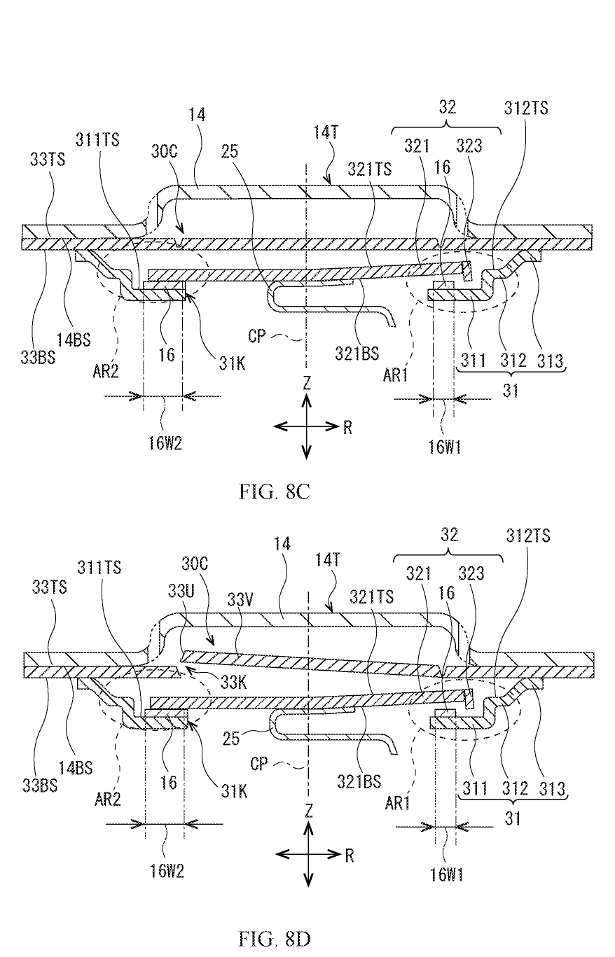

FIG. 8A is a sectional diagram illustrating a configuration example of a safety valve mechanism 30C according to a third modification example (Modification example 1-3) of the first example embodiment. FIG. 8B is a plan diagram illustrating the configuration example of the safety valve mechanism 30C illustrated in FIG. 8A. Note that FIG. 8A corresponds to a section in an arrow direction along line VIII-VIII illustrated in FIG. 8B. In the safety valve mechanism 30 according to the example embodiment described above, the coupling part 322 may couple the body part 321 and the second tread part 312 to each other in the first joining region AR1 to achieve electrical coupling between the first electrically conductive member 31 and the second electrically conductive member 32; and when the internal pressure of the battery can 11 increases, the coupling part 322 may break to cut off the current path. In contrast, the safety valve mechanism 30C illustrated in FIGS. 8A and 8B may include a terminal 323 instead of the coupling part 322 in the second electrically conductive member 32 in the first joining region AR1. The terminal 323 may be attached to, for example, the vicinity of an end face of the body part 321. Upon normal use, the terminal 323 may be biased toward the upper surface 311TS of the first tread part 311 of the first electrically conductive member 31, and may abut against the upper surface 311TS. The terminal 323 may include, for example, any one or more of metal materials. Non-limiting examples of the metal materials may include a simple substance of iron, a simple substance of aluminum, and an alloy including iron, aluminum, or both.

FIGS. 8C and 8D are each an explanatory diagram describing behavior at a time of an increase in internal pressure, of a secondary battery including the safety valve mechanism 30C illustrated in FIGS. 8A and 8B. An operation at the time of an increase in internal pressure will be described below. In the secondary battery including the safety valve mechanism 30C also, the current path from the battery device 20 to the battery cover 14 may be configured to be cut off by generation of a gap between the first electrically conductive member 31 and the second electrically conductive member 32, caused by an increase in internal pressure of the battery can 11 containing the battery device 20.

For example, when the secondary battery is operating normally, in the first joining region AR1, the body part 321 may be joined to the first tread part 311 via the sealing part 16, and may be electrically continuous with the first tread part 311 via the terminal 323, as illustrated in FIG. 8A. The opening 31K of the first electrically conductive member 31 may thus be closed by the second electrically conductive member 32.

When a gas is generated inside the battery can 11 due to a side reaction such as the decomposition reaction of the electrolytic solution, the generated gas may be accumulated inside the battery can 11, and the internal pressure of the battery can 11 may increase. Here, when the internal pressure of the battery can 11 reaches a certain level or higher, the sealing part 16, which seals the body part 321 and the first tread part 311, may so cleave in part that the body part 321 is separated from the first tread part 311 in the first joining region AR1, as illustrated in FIG. 8C. This may allow the space inside the battery can 11 and the space between the first electrically conductive member 31 and the third electrically conductive member 33 of the safety valve mechanism 30C to be continuous through the opening 31K. At this time, in the first joining region AR1, a part of the body part 321 may be separated from the sealing part 16, and the terminal 323 may be separated from the first tread part 311 at the same time or at substantially the same time. This may cut off the electrical continuity between the body part 321 coupled to the positive electrode lead 25, and the first electrically conductive member 31, and may thus cut off the current path inside the secondary battery. As a result, the battery reaction may stop. In addition, when the internal pressure of the battery can 11 increases, a part of the grooved part 33U of the third electrically conductive member 33 may break, and the valve part 33V may thus cleave in part, as illustrated in FIG. 8D. This may provide the opening 33K in the third electrically conductive member 33, and may thus open a gas releasing path using the openings 31K and 33K and the through hole H14. As a result, the gas generated inside the battery can 11 is released to the outside of the secondary battery via the openings 31K and 33K and the through hole H14.

Note that in the safety valve mechanism 30C according to Modification example 1-3, an outer shape of the terminal 323 may be selected as desired. For example, the terminal 323 illustrated in FIGS. 8A to 8D may have an outer shape that is substantially circular columnar. In an embodiment, however, the terminal 323 may have an outer shape that is spherical, hemispherical, conical, or prismatic.

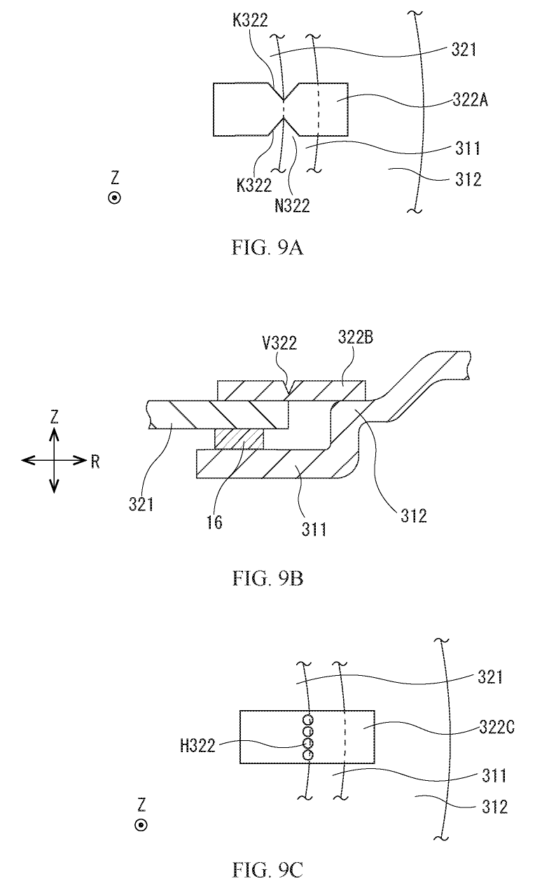

FIG. 9A is a plan diagram illustrating a configuration example of a coupling part 322A according to a fourth modification example (Modification example 1-4) of the first example embodiment. The safety valve mechanism 30 according to the example embodiment described above may include the coupling part 322 having a strip shape in a plan view as illustrated in FIG. 3; however, the shape of the coupling part according to an embodiment of the present disclosure is not limited thereto. For example, as the coupling part 322A illustrated in FIG. 9A, the coupling part may include a narrow part N322 having a cutout K322 in a part of an outer edge of the coupling part. In the example illustrated in FIG. 9A, the coupling part 322A may have two cutouts K322. A position of each of the two cutouts K322 may substantially coincide with a position of an outer edge of the body part 321 of the first electrically conductive member 31 in the Z direction. The coupling part 322A may break more easily at the two cutouts K322. This helps to decrease a breakage strength as compared with the coupling part 322.

FIG. 9B is a sectional diagram illustrating a configuration example of a coupling part 322B according to a fifth modification example (Modification example 1-5) of the first example embodiment. The coupling part 322A according to Modification example 1-4 described above may have the cutout K322 at the outer edge in a plan view; however, the shape of the coupling part according to an embodiment of the present disclosure is not limited thereto. In an embodiment, as the coupling part 322B illustrated in FIG. 9B, the coupling part may have a groove V322 in a part of a surface of the coupling part. In an embodiment, a position of the groove V322 may substantially coincide with the position of the outer edge of the body part 321 of the first electrically conductive member 31 in the Z direction. The coupling part 322B may break more easily at the groove V322. This helps to decrease the breakage strength as compared with the coupling part 322.

FIG. 9C is a plan diagram illustrating a configuration example of a coupling part 322C according to a sixth modification example (Modification example 1-6) of the first example embodiment. The coupling part 322A according to Modification example 1-4 described above may have the cutout K322 at the outer edge in a plan view; however, the shape of the coupling part according to an embodiment of the present disclosure is not limited thereto. In an embodiment, as the coupling part 322C illustrated in FIG. 9C, the coupling part may have one or more holes H322. In the example illustrated in FIG. 9C, the coupling part 322C may have four holes H322. In an embodiment, a position of each of the four holes H322 may substantially coincide with the position of the outer edge of the body part 321 of the first electrically conductive member 31 in the Z direction. The coupling part 322C may break more easily near the four holes H322. This helps to decrease the breakage strength as compared with the coupling part 322.

In the secondary battery 1 according to the first example embodiment, the battery cover 14 may have the through hole H14. However, as a secondary battery according to Modification example 1-7 of the example embodiment of the present disclosure, the battery cover 14 does not necessarily have to have the through hole H14 at the projecting part 14T.

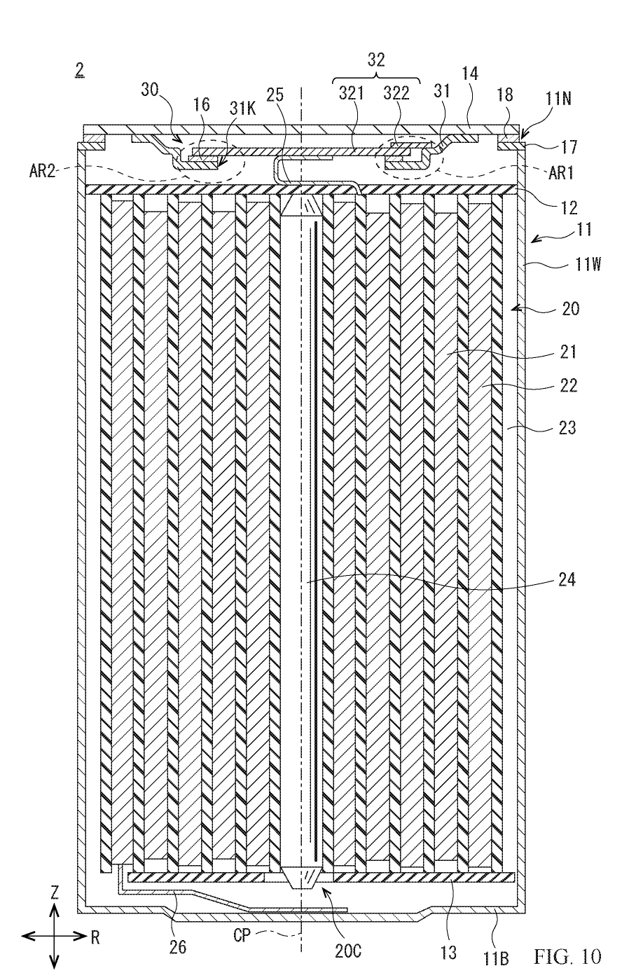

Next, a description is given of a secondary battery 2 according to a second example embodiment of the present disclosure with reference to FIG. 10. The first example embodiment has been described above referring to, as an example, the cylindrical secondary battery that includes the battery can 11 including the crimped structure 11R. In contrast, the secondary battery 2 according to the second example embodiment may be of what is called a beadless structure, which may include no crimped structure. FIG. 10 illustrates a sectional configuration of the secondary battery 2 according to the second example embodiment.

In the secondary battery 2 according to the second example embodiment, the battery can 11 may include no crimped structure, as illustrated in FIG. 10. The battery can 11 may be a container that includes a wall part 11W and a bottom part 11B. The wall part 11W may have a cylindrical shape, and may include the open end part 11N at an upper end part thereof. The bottom part 11B may close a lower end part of the wall part 11W. The wall part 11W may include, for example, no narrow part 11S and no bent part 11P, and may extend in the Z direction. For example, a lower surface of a plate-shaped member 17 having an annular shape may be joined to the open end part 11N of the battery can 11. The battery cover 14 may be joined to an upper surface of the plate-shaped member 17 via a sealing part 18. The battery cover 14 may be a flat circular-plate-shaped member including no projecting part. The sealing part 18 may include, for example, a thermoplastic insulating resin such as polypropylene or polyethylene. The safety valve mechanism 30 sandwiched between the battery cover 14 and the insulating plate 12 may be joined to the battery cover 14. Here, the sealing part 18 may correspond to a specific but non-limiting example of the "first insulating part" in an embodiment of the present disclosure.

In an embodiment, a third joining strength with which the battery can 11 and the battery cover 14 are joined to each other via the sealing part 18 may be higher than the first joining strength with which the first electrically conductive member 31 and the second electrically conductive member 32 are joined to each other in the first joining region AR1.

The secondary battery 2 according to the second example embodiment may also have behavior similar to that of the secondary battery 1 according to the first example embodiment described above. For example, the current path from the battery device 20 to the battery cover 14 may be configured to be cut off by generation of a gap between the first electrically conductive member 31 and the second electrically conductive member 32, when the internal pressure of the battery can 11 containing the battery device 20 increases.

For example, when the secondary battery 2 is operating normally, in the first joining region AR1, the body part 321 may be joined to the first tread part 311 via the sealing part 16, and may be electrically continuous with the second tread part 312 via the coupling part 322, as illustrated in FIG. 10. The opening 31K of the first electrically conductive member 31 may thus be closed by the second electrically conductive member 32.

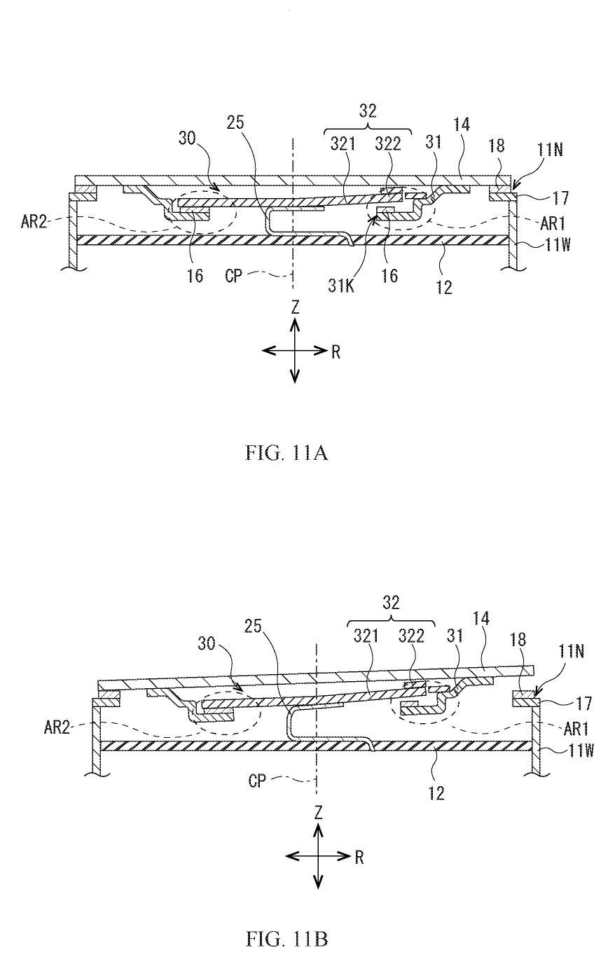

When a gas is generated inside the battery can 11 due to a side reaction such as the decomposition reaction of the electrolytic solution, the generated gas may be accumulated inside the battery can 11, and the internal pressure of the battery can 11 may increase. Here, when the internal pressure of the battery can 11 reaches a certain level or higher, the sealing part 16, which seals the body part 321 and the first electrically conductive member 31, may so cleave in part that the body part 321 is separated from the first electrically conductive member 31 in the first joining region AR1, as illustrated in FIG. 11A. This may allow the space inside the battery can 11 and the space between the safety valve mechanism 30 and the battery cover 14 to be continuous through the opening 31K. As a result, the gas generated inside the battery can 11 may be released through the opening 31K into the space between the safety valve mechanism 30 and the battery cover 14. In addition, the coupling part 322 may break when the body part 321 is separated from the first electrically conductive member 31 in the first joining region AR1. This may cut off the electrical continuity between the body part 321 coupled to the positive electrode lead 25, and the first electrically conductive member 31, and may thus cut off the current path inside the secondary battery2. As a result, the battery reaction may stop.

Thereafter, when the internal pressure of the secondary battery 2 further increases, the battery cover 14 may be detached from the plate-shaped member 17 joined to the battery can 11, for example, as illustrated in FIG. 11B, and the gas may thus be released to the outside of the secondary battery 2. Note that FIGS. 11A and 11B are each an explanatory diagram describing behavior of the secondary battery 2 according to the second example embodiment at a time when the internal pressure of the secondary battery 2 increases.

As described above, the secondary battery 2 according to the second example embodiment may also include the safety valve mechanism 30, and thus helps to achieve effects similar to those achieved by the secondary battery 1 according to the first example embodiment described above.

Next, a description is given of applications (application examples) of the secondary battery according to an embodiment.

The applications of the secondary battery are not particularly limited. The secondary battery used as a power source may serve as a main power source or an auxiliary power source in, for example but not limited to, electronic equipment, an electric vehicle, or any other application in which any embodiment of the present disclosure is usable. The main power source may be preferentially used regardless of the presence of any other power source. The auxiliary power source may be used in place of the main power source, or may be switched from the main power source.

Non-limiting examples of the applications of the secondary battery may include: electronic equipment; apparatuses for data storage; electric power tools; battery packs to be mounted on, for example but not limited to, electronic equipment; medical electronic equipment; electric vehicles; and electric power storage systems. Non-limiting examples of the electronic equipment may include video cameras, digital still cameras, mobile phones, laptop personal computers, headphone stereos, portable radios, portable information terminals, and any other electronic equipment to which any embodiment of the present disclosure is applicable. Non-limiting examples of the apparatuses for data storage may include backup power sources, memory cards, and any other apparatus for data storage to which any embodiment of the present disclosure is applicable. Non-limiting examples of the electric power tools may include electric drills, electric saws, and any other electric power tool to which any embodiment of the present disclosure is applicable. Non-limiting examples of the medical electronic equipment may include pacemakers, hearing aids, and any other medical electronic equipment to which any embodiment of the present disclosure is applicable. Non-limiting examples of the electric vehicles may include electric automobiles including hybrid automobiles, and any other electric vehicle to which any embodiment of the present disclosure is applicable. Non-limiting examples of the electric power storage systems may include battery systems for home use or industrial use in which electric power is accumulated for a situation such as emergency, and any other electric power storage system to which any embodiment of the present disclosure is applicable. In an embodiment, one secondary battery may be used in each of the above-described applications. In an embodiment, multiple secondary batteries may be used in each of the above-described applications.

In an embodiment, the battery packs may each include a battery cell. In an embodiment, the battery packs may each include an assembled battery. In an embodiment, the electric vehicle may be a vehicle that operates or travels with the secondary battery as a driving power source, and may be a hybrid automobile that is additionally provided with a driving source other than the secondary battery. In the electric power storage system for home use, electric power accumulated in the secondary battery serving as an electric power storage source may be utilized for using, for example but not limited to, home appliances and any other electrical appliance.

An application example of the secondary battery will now be described in detail. The configuration of the application example described below is merely an example, and is appropriately modifiable.

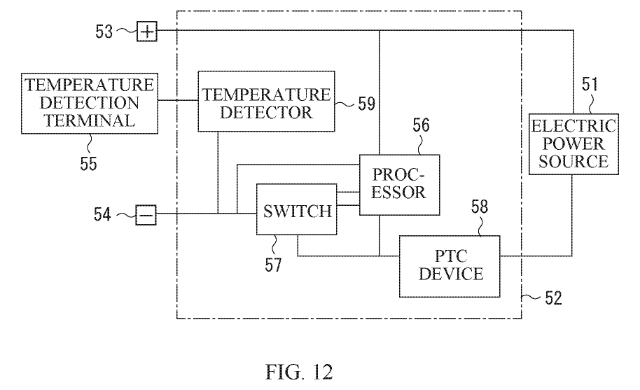

FIG. 12 illustrates a block configuration of a battery pack. The battery pack described here may be a battery pack, e.g., what is called a soft pack, including one secondary battery, and may be to be mounted on, for example, electronic equipment typified by a smartphone.

As illustrated in FIG. 12, the battery pack may include an electric power source 51 and a circuit board 52. The circuit board 52 may be coupled to the electric power source 51, and may include a positive electrode terminal 53, a negative electrode terminal 54, and a temperature detection terminal 55.

The electric power source 51 may include one secondary battery. The secondary battery may have a positive electrode lead coupled to the positive electrode terminal 53 and a negative electrode lead coupled to the negative electrode terminal 54. The electric power source 51 may be couplable to outside via the positive electrode terminal 53 and the negative electrode terminal 54, and may thus be chargeable and dischargeable. The circuit board 52 may include a processor 56, a switch 57, a thermosensitive resistive device (a PTC device) 58, and a temperature detector 59. However, in an embodiment, the PTC device 58 may be omitted.

The processor 56 may include, for example, a central processing unit (CPU) and a memory, and may control an overall operation of the battery pack. The processor 56 may detect and control a use state of the electric power source 51 on an as-needed basis.

If a voltage of the electric power source 51 (the secondary battery) reaches an overcharge detection voltage or an overdischarge detection voltage, the processor 56 may turn off the switch 57. This helps to prevent a charging current from flowing into a current path of the electric power source 51. For example, the overcharge detection voltage may be 4.2 V ± 0.05 V and the overdischarge detection voltage may be 2.4 V ± 0.1 V.

The switch 57 may include, for example, a charge control switch, a discharge control switch, a charging diode, and a discharging diode. The switch 57 may perform switching between coupling and decoupling between the electric power source 51 and external equipment in accordance with an instruction from the processor 56. The switch 57 may include, for example, a metal-oxide-semiconductor field-effect transistor (MOSFET). The charging and discharging currents may be detected based on an ON-resistance of the switch 57.

The temperature detector 59 may include a temperature detection device such as a thermistor. The temperature detector 59 may measure a temperature of the electric power source 51 using the temperature detection terminal 55 and may output a result of the temperature measurement to the processor 56. The result of the temperature measurement to be obtained by the temperature detector 59 may be used, for example, when the processor 56 performs charge and discharge control upon abnormal heat generation or when the processor 56 performs a correction process upon calculating a remaining capacity.

Although an embodiment of the present disclosure have been described hereinabove with reference to some example embodiments and some modification examples, the configuration of an embodiment of the present disclosure is not limited to the configurations described in relation to the example embodiments and the modification examples above, and is therefore modifiable in a variety of ways.

For example, the description has been given of the case where the battery device has a device structure of a wound type. However, the device structure of the battery device is not particularly limited. In an embodiment, the device structure may thus be another device structure such as a stacked type in which the electrodes, i.e., the positive electrode and the negative electrode, are stacked on each other, or a zigzag folded type in which the electrodes, i.e., the positive electrode and the negative electrode, are folded in a zigzag manner.

Further, although the description has been given of the case where the electrode reactant is lithium, the electrode reactant is not particularly limited. In an embodiment, the electrode reactant may be another alkali metal such as sodium or potassium, as described above. In an embodiment, the electrode reactant may be an alkaline earth metal such as beryllium, magnesium, or calcium, as described above. In an embodiment, the electrode reactant may be another light metal such as aluminum.

The effects described herein are mere examples, and effects of an embodiment of the present disclosure are therefore not limited to those described herein. Accordingly, an embodiment of the present disclosure may achieve any other effect.

Furthermore, the present disclosure encompasses any possible combination of some or all of the various embodiments and the modification examples described herein and incorporated herein. It is possible to achieve at least the following configurations from the above-described example embodiments of the present disclosure.

(1)

A secondary battery including:

a battery device to which a lead is coupled;

a container containing the battery device;

a cover part covering the container and the battery device contained in the container; and

a first insulating part sealing the container and the cover part, in which the cover part includes

a first electrically conductive member having an opening, and

a second electrically conductive member attached to the first electrically conductive member via a second insulating part and covering the opening, the second electrically conductive member being coupled to the lead through the opening,

the cover part includes a first joining region and a second joining region in each of which the first electrically conductive member and the second electrically conductive member are mechanically joined to each other,

in the first joining region, the first electrically conductive member and the second electrically conductive member are electrically coupled to each other,

in the second joining region, the first electrically conductive member and the second electrically conductive member are electrically insulated from each other, and

a second joining strength with which the first electrically conductive member and the second electrically conductive member are joined to each other in the second joining region is higher than a first joining strength with which the first electrically conductive member and the second electrically conductive member are joined to each other in the first joining region.

(2)

The secondary battery according to (1), in which

the second electrically conductive member includes a body part and a coupling part,

in the first joining region, the body part is electrically coupled to and mechanically joined to the first electrically conductive member via the coupling part, and

in the second joining region, the body part is mechanically joined to the first electrically conductive member via the second insulating part.

(3)

The secondary battery according to (2), in which in the first joining region, the body part is mechanically joined to the first electrically conductive member via the second insulating part.

(4)

The secondary battery according to (2) or (3), in which a thickness of the coupling part is smaller than a thickness of the body part.

(5)

The secondary battery according to any one of (2) to (4), in which the coupling part has at least one of a narrow part, a hole, or a groove.

(6)

The secondary battery according to (1), in which

the second electrically conductive member includes a body part and a terminal, and

in the first joining region, the body part is mechanically joined to the first electrically conductive member via the second insulating part, and the terminal is biased toward the first electrically conductive member and abuts against the first electrically conductive member.

(7)

The secondary battery according to any one of (1) to (6), in which a third joining strength with which the container and the cover part are joined to each other via the first insulating part is higher than the first joining strength.

(8)

A secondary battery including:

a battery device to which a lead is coupled;

a container containing the battery device;

a cover part covering the container and the battery device contained in the container; and

a first insulating part sealing the container and the cover part, in which the cover part includes

a first electrically conductive member having an opening, and

a second electrically conductive member attached to the first electrically conductive member via a second insulating part and covering the opening, the second electrically conductive member being coupled to the lead through the opening, and

a current path from the battery device to the cover part is configured to be cut off by generation of a gap between the first electrically conductive member and the second electrically conductive member caused by an increase in internal pressure of the container.

According to a secondary battery according to at least one example embodiment of the present disclosure, when a pressure inside a container increases due to gas generation, a current path that is provided from a battery device to a first electrically conductive member via a second electrically conductive member is cut off. This helps to stop proceeding of a battery reaction, and thus helps to secure safety.

Note that effects of an embodiment of the present disclosure are not necessarily limited to the example effects described above and may include any of a series of effects described herein in relation to the example embodiments of the present disclosure and the modification examples thereof.

Although the present disclosure has been described hereinabove in terms of the example embodiment and modification examples, the present disclosure is not limited thereto. It should be appreciated that variations may be made in the described example embodiment and modification examples by those skilled in the art without departing from the scope of the present disclosure as defined by the following claims. The limitations in the claims are to be interpreted broadly based on the language employed in the claims and not limited to examples described in this specification or during the prosecution of the application, and the examples are to be construed as non-exclusive. As used in this specification and the appended claims, the singular forms "a," "an," and "the" include, especially in the context of the claims, are to be construed to cover both the singular and the plural, unless otherwise indicated herein or clearly contradicted by context. Throughout this specification and the appended claims, unless the context requires otherwise, the terms "comprise", "include", "have", and their variations are to be construed to cover the inclusion of a stated element, integer, or step but not the exclusion of any other non-stated element, integer, or step. The use of the terms first, second, etc. do not denote any order or importance, but rather the terms first, second, etc. are used to distinguish one element from another. The term "substantially", "approximately", "about", and its variants having the similar meaning thereto are defined as being largely but not necessarily wholly what is specified as understood by one of ordinary skill in the art. The term "disposed on/ provided on/ formed on" and its variants having the similar meaning thereto as used herein refer to elements disposed directly in contact with each other or indirectly by having intervening structures therebetween.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a battery device to which a lead is coupled;
a container containing the battery device;
a cover part covering the container and the battery device contained in the container; and
a first insulating part sealing the container and the cover part, wherein
the cover part includes
a first electrically conductive member having an opening, and
a second electrically conductive member attached to the first electrically conductive member via a second insulating part and covering the opening, the second electrically conductive member being coupled to the lead through the opening,
the cover part includes a first joining region and a second joining region in each of which the first electrically conductive member and the second electrically conductive member are mechanically joined to each other,
in the first joining region, the first electrically conductive member and the second electrically conductive member are electrically coupled to each other,
in the second joining region, the first electrically conductive member and the second electrically conductive member are electrically insulated from each other, and
a second joining strength with which the first electrically conductive member and the second electrically conductive member are joined to each other in the second joining region is higher than a first joining strength with which the first electrically conductive member and the second electrically conductive member are joined to each other in the first joining region.

2. The secondary battery according to claim 1, wherein
the second electrically conductive member includes a body part and a coupling part,
in the first joining region, the body part is electrically coupled to and mechanically joined to the first electrically conductive member via the coupling part, and
in the second joining region, the body part is mechanically joined to the first electrically conductive member via the second insulating part.

3. The secondary battery according to claim 2, wherein in the first joining region, the body part is mechanically joined to the first electrically conductive member via the second insulating part.

4. The secondary battery according to claim 2, wherein a thickness of the coupling part is smaller than a thickness of the body part.

5. The secondary battery according to claim 2, wherein the coupling part has at least one of a narrow part, a hole, or a groove.

6. The secondary battery according to claim 1, wherein
the second electrically conductive member includes a body part and a terminal, and
in the first joining region, the body part is mechanically joined to the first electrically conductive member via the second insulating part, and the terminal is biased toward the first electrically conductive member and abuts against the first electrically conductive member.

7. The secondary battery according to claim 1, wherein a third joining strength with which the container and the cover part are joined to each other via the first insulating part is higher than the first joining strength.

8. A secondary battery comprising:
a battery device to which a lead is coupled;
a container containing the battery device;
a cover part covering the container and the battery device contained in the container; and
a first insulating part sealing the container and the cover part, wherein
the cover part includes
a first electrically conductive member having an opening, and
a second electrically conductive member attached to the first electrically conductive member via a second insulating part and covering the opening, the second electrically conductive member being coupled to the lead through the opening, and
a current path from the battery device to the cover part is configured to be cut off by generation of a gap between the first electrically conductive member and the second electrically conductive member caused by an increase in internal pressure of the container.
